(19) United States
(12) Patent Application Publication
(10) Pub. No.: US 2016/0193021 A1
(43) Pub. Date: Jul. 7, 2016

(54) Floss pick

(71) Applicant: Wan Zhi LIANG, Taiwan (CN)

(72) Inventor: Sin-Cheng Lin, Tainan (TW)

(21) Appl. No.: 14/915,910

(22) PCT Filed: Sep. 4, 2014
(86) PCT No.: PCT/CN2014/085911

§ 371 Date: Mar. 2, 2016

(30) Foreign Application Priority Data
Sep. 4, 2013 (CN) 201310396866.4

(51) Int. Cl. A61C 15/04; A61C 15/02

(52) U.S. Cl. CPC A61C 15/046; A61C 15/02; A61C 15/041

(57) ABSTRACT

A floss pick includes a holding portion; and a floss portion connected with the front end of the holding portion. The floss portion comprises a bridge rod, two prongs, extending from both ends of the bridge rod separately, and a floss piece, connecting between two prongs. The two prongs bend to the same side in an arc shape. A turning portion is formed between the holding portion and the bridge rod, making the edge line of the upper part of the holding portion to be aligned with the centerline of the top surface of the bridge rod. By having the two prongs bending to the same side in an arc shape, the floss pick allows a user to easily reach diastemata in the back of the mouth so that the user does not need to widely open his/her mouth.

### BACKGROUND OF THE INVENTION

1. Field of the Invention

The invention relates to floss picks and more particularly to a floss pick having improved characteristics including allowing a user to conveniently clean diastemata near molar teeth at the back of the mouth and feel more comfortably while using the floss pick.

2. Description of Related Art

Currently, for the personal Oral hygiene habit, the cleaning methods for teeth usually are to rinse the mouth with mouthwash liquid, brush teeth with the toothpaste and toothbrush directly, or use the floss pick, interdental brush, or the floss to remove food particles and dental plaques from between teeth. However, the critical method to prevent teeth from tooth diseases or cavities is to clean up food plaques from between teeth. Thus, among the aforementioned dental cleaning methods, using the floss pick is the most effective one to remove food plaques.

Generally, one end of the body of a regular floss pick has a F-shaped or Y-shaped structure with two prongs extending from the body where a floss piece is mounted in between for users to remove food and dental plaques from diastemata. However, users frequently find themselves having difficulty to use a F-shaped or Y-shaped floss pick to clean diastemata located at the back of the mouth. Such inconvenience may reduce the frequency of using floss picks as a whole.

Thus, the need for improvement still exists.

### SUMMARY OF THE INVENTION

A main objective of the invention is to provide an improved structure of floss pick with the F-shaped structure bent in an arc shape holding both ends of the floss piece that allows users to reach diastemata in the back of the mouth easier so that users do not need to wide open their mouths. Therefore, users feel more comfortable while using the floss picks and are able to remove food particles completely.

In order to achieve the aforementioned objective, the invention is to provide an improved structure of floss pick that mainly comprises a holding portion and a floss portion which is connected with the front end of the holding portion. The floss portion comprises a bridge rod, two prongs, extending from both ends of the bridge rod separately, and a floss piece, connecting between two prongs, wherein the two prongs bend to the same side in an arc shape; a turning portion, formed between the holding portion and the bridge rod, makes the edge line of the upper part of the holding portion is aligned with the centerline of the top surface of the bridge rod; the floss piece and the holding portion are in the same surface but not aligned; a slipperiness preventing slope is formed on each side surface of the holding portion wherein two side surfaces of each pair are opposite to each other separately; a toothpick portion is formed at the end of the holding portion and a tilting tip made of soft material is set on the toothpick portion.

A floss pick of the invention comprises a holding portion and a floss portion which is connected with the front end of the holding portion. The floss portion comprises a bridge rod, two prongs, extending from both ends of the bridge rod separately, and a floss piece, connecting between two prongs, wherein the two prongs bend to the same side in an arc shape; a turning portion, formed between the holding portion and the bridge rod, makes the edge line of the upper part of the holding portion to extend to the centerline of the top surface of the bridge rod with an angle; the floss piece and the holding portion are in the same surface but not aligned; a slipperiness preventing slope is formed on each side surface of the holding portion wherein two side surfaces of each pair are opposite to each other separately; a toothpick portion is formed at the end of the holding portion and a tilting tip made of soft material is set on the toothpick portion.

The floss pick of the invention has the following advantages:

1. By having two prongs bending to the same side in an arc shape, the improved structure of floss pick of the invention allows users to better clean diastemata at the back of the mouth, feel more comfortably while using the floss picks, and achieve a better effect of preventing dental diseases and cavities.

2. By having a slipperiness preventing slope formed on each side surface of the holding portion wherein two side surfaces of each pair are opposite to each other separately, the improved structure of floss pick of the invention offers users a better and easier way of holding the floss pick, whereas a toothpick portion formed at the end of the holding portion is an additional device for cleaning diastemata as well, so that the floss pick achieves a better effect of preventing dental diseases and cavities.

3. By having a toothpick portion made of a soft material and a tilting tip formed at the end of the holding portion, the improved structure of floss pick of the invention can completely remove food particles from diastemata and will not damage teeth.

The above and other objects, features and advantages of the invention will become apparent from the following detailed description taken with the accompanying drawings.

### BRIEF DESCRIPTION OF THE DRAWINGS

FIG. 1 is a perspective view of a floss pick of a first preferred embodiment of the invention;

FIG. 2 is a view similar to FIG. 1;

FIG. 3 is a cross-sectional view taken along lines A-A of FIG. 2;

FIG. 4 is a perspective view of a floss pick of a second preferred embodiment of the invention;

FIG. 5 is a perspective view of a floss pick of a third preferred embodiment of the invention; and

FIG. 6 is an environmental view showing the floss pick being used to clean diastemata near molar teeth.

### DETAILED DESCRIPTION OF THE INVENTION

The following detailed descriptions and figures are exemplary embodiments for better understanding the objective, effect, and characteristics of the invention.

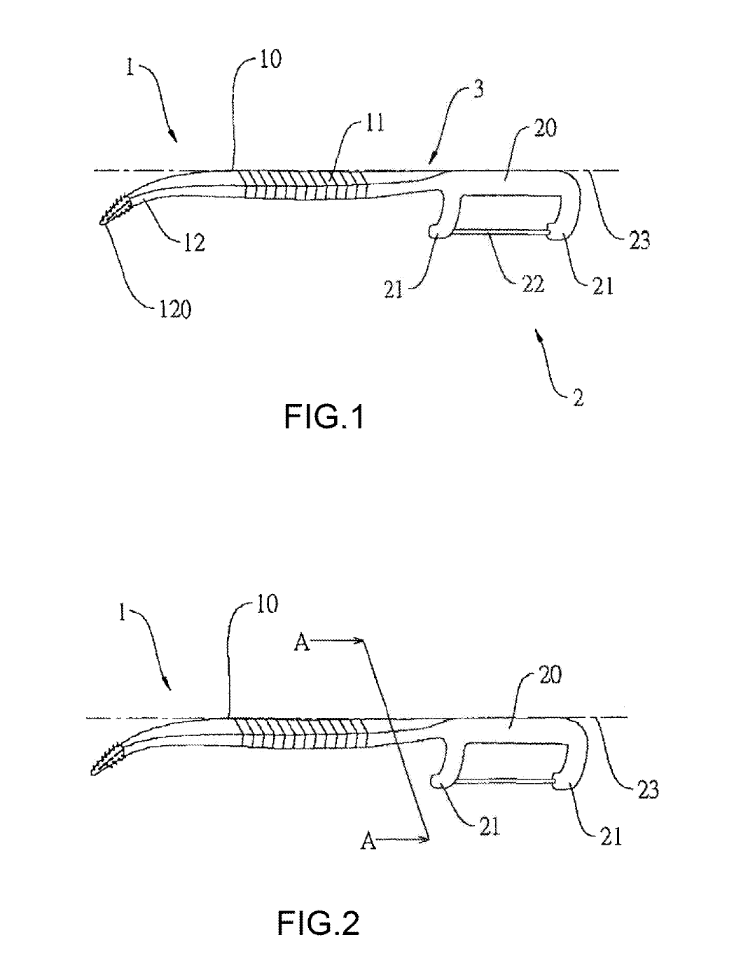

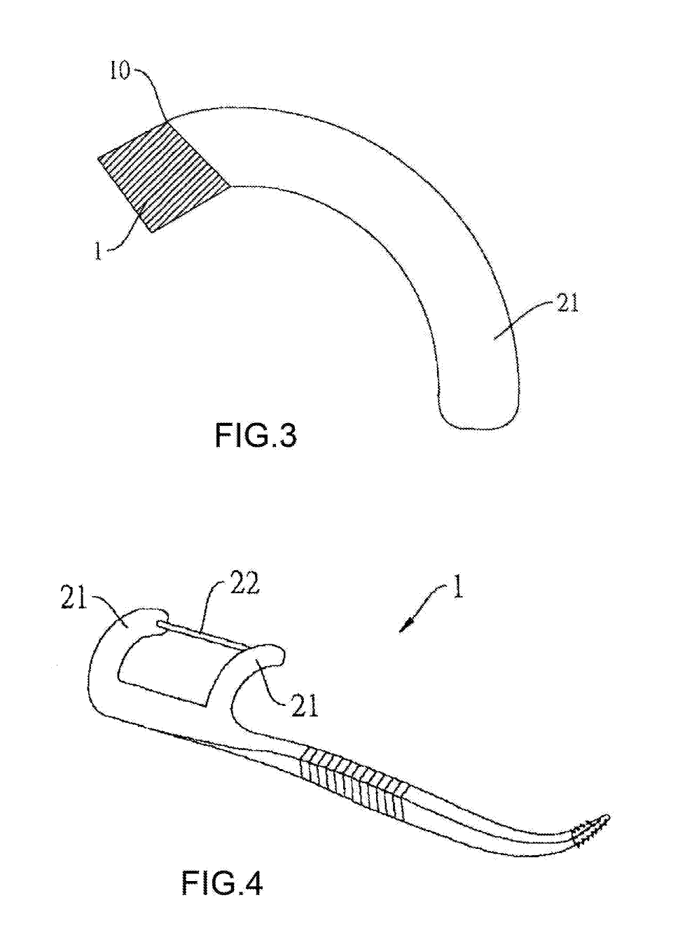

Referring to FIGS. 1 to 3, a floss pick of a first preferred embodiment of the invention comprises a holding portion 1 and a floss portion 2 which is connected with the front end of the holding portion 1. The floss portion 2 comprises a bridge rod 20, two prongs 21, extending from both ends of the bridge rod 20 separately, and a floss piece 22, connecting between two prongs 21, wherein the two prongs 12 bend to the same side in an arc shape; a turning portion 3, formed between the holding portion 1 and the bridge rod 20, makes the edge line of the upper part of the holding portion 1 is aligned with the centerline of the top surface of the bridge rod 20.

In addition to the aforementioned elements, a slipperiness preventing slope 11 is formed on each side surface of the holding portion 1 of the invention wherein two side surfaces of each pair are opposite to each other separately. A toothpick portion 12 is formed at the end of the holding portion 1 and a tilting tip 120 made of soft material is set on the toothpick portion 12, so that teeth will not be damaged while being cleaned.

Referring to FIG. 4, a floss pick of a second preferred embodiment of the invention is shown. The two prongs 21 are designed to bend to the same side in an arc shape. Therefore, the two prongs 21 can also bend to the other side in an arc shape to form another design. Furthermore, the floss piece 22 and the holding portion 1 are in the same surface but not aligned.

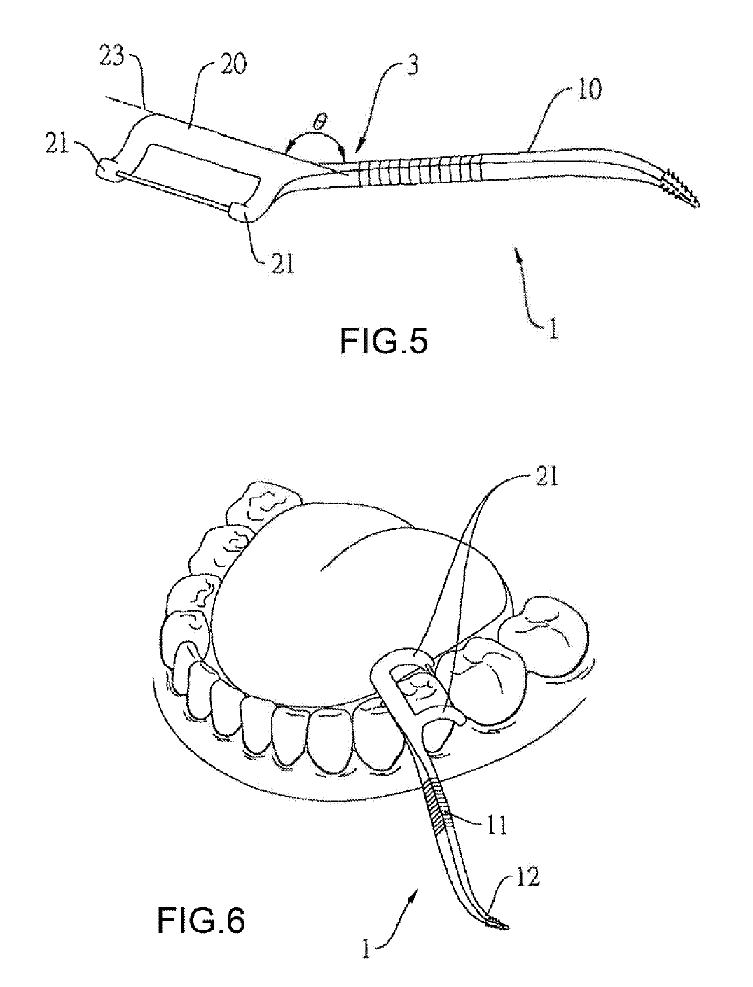

Referring to FIG. 5, a floss pick of a third preferred embodiment of the invention is shown. The two prongs 21 bend to the same side in an arc shape and a turning portion 3 is formed between the holding portion 1 and the bridge rod 20, having the edge line 10 of the upper part of the holding portion 1 to extend to the centerline of the top surface of the bridge rod 20 with an angle θ, so that when users easily hold and use the invention due to the design of adding the angle.

Referring to FIG. 6, in use by having two prongs 21 bending to the same side in an arc shape, the invention allows users to feel more comfortably while cleaning diastemata at the back of the mouth and to achieve the effect of cleaning diastemata and preventing dental diseases and cavities.

Furthermore, by having a slipperiness preventing slope 11 formed on each side surface of the holding portion 1 wherein two side surfaces of each pair are opposite to each other separately, users have a better and easier way of holding the floss pick. Meanwhile, the toothpick portion 12 formed at the end of the holding portion 1 is an additional device for cleaning diastemata in order to achieve the effect of preventing dental diseases and cavities.

While the invention has been described in terms of preferred embodiments, those skilled in the art will recognize that the invention can be practiced with modifications within the spirit and scope of the appended claims.

What is claimed is:

1. A floss pick comprising:
a holding portion; and
a floss portion connected with the front end of the holding portion;
wherein the floss portion comprises a bridge rod, two prongs, extending from both ends of the bridge rod separately, and a floss piece, connecting between two prongs;
wherein the two prongs bend to the same side in an arc shape; and
wherein a turning portion is formed between the holding portion and the bridge rod, making the edge line of the upper part of the holding portion to be aligned with the centerline of the top surface of the bridge rod.

2. The floss pick as claimed in claim 1, wherein the floss piece and the holding portion are in the same surface but not aligned.

3. The floss pick as claimed in claim 1, wherein a slipperiness preventing slope is formed on each side surface of the holding portion, and wherein two side surfaces of each pair are opposite to each other separately.

4. The floss pick as claimed in claim 1, wherein a toothpick portion is formed at the end of the holding portion and a tilting tip made of soft material is set on the toothpick portion.

5. A floss pick comprising:
a holding portion; and
a floss portion connected with the front end of the holding portion;
wherein the floss portion comprises a bridge rod, two prongs, extending from both ends of the bridge rod separately, and a floss piece, connecting between two prongs;
wherein the two prongs bend to the same side in an arc shape; and
wherein a turning portion is formed between the holding portion and the bridge rod, making the edge line of the upper part of the holding portion to extend to the centerline of the top surface of the bridge rod with an angle.

6. The floss pick as claimed in claim 5, wherein the floss piece and the holding portion are in the same surface but not aligned.

7. The floss pick as claimed in claim 5, wherein a slipperiness preventing slope is formed on each side surface of the holding portion, and wherein two side surfaces of each pair are opposite to each other separately.

8. The floss pick as claimed in claim 5, wherein a toothpick portion is formed at the end of the holding portion and a tilting tip made of soft material is set on the toothpick portion.
